(19) United States
(12) Patent Application Publication
(10) Pub. No.: US 2022/0111799 A1
(43) Pub. Date: Apr. 14, 2022

(54) VEHICLE SENSOR ATTACHMENT STRUCTURE

(71) Applicant: TOYOTA JIDOSHA KABUSHIKI KAISHA, Toyota-shi (JP)

(72) Inventors: Taro Hasegawa, Toyota-shi (JP); Naoya Higashimachi, Toyota-shi (JP); Wataru Matsubara, Toyota-shi (JP)

(73) Assignee: TOYOTA JIDOSHA KABUSHIKI KAISHA, Toyota-shi (JP)

(21) Appl. No.: 17/379,650

(22) Filed: Jul. 19, 2021

(30) Foreign Application Priority Data
Oct. 12, 2020 (JP) 2020-171757

(51) Int. Cl. B60R 11/04

(52) U.S. Cl. CPC B60R 11/04; B60R 2011/004

(57) ABSTRACT

Provided is a vehicle sensor attachment structure in which a camera and a LIDAR configured to detect an external environment around a vehicle are attached to the vehicle. The vehicle sensor attachment structure includes a sensor unit in which the camera and the LIDAR are provided in an integrated manner, the sensor unit being attached to a front face or a rear face of a vehicle body of the vehicle.

### CROSS-REFERENCE TO RELATED APPLICATION

This application claims priority to Japanese Patent Application No. 2020-171757 filed on Oct. 12, 2020, incorporated herein by reference in its entirety.

### BACKGROUND

### 1. Technical Field

The present disclosure relates to a vehicle sensor attachment structure.

### 2. Description of Related Art

In the related art, US Patent Application Publication No. 2016/0334790 is known as a technical literature related to a vehicle sensor attachment structure. The publication describes a structure in which sensors are placed on the center of a roof of a vehicle in an integrated manner.

### SUMMARY

However, in the structure where the sensors are collectively provided on the center of the roof of the vehicle, blind spots for the sensors easily occur in the vehicle front-rear direction due to end parts of the roof. In this case, when the attachment positions of the sensors are set to be high in order to reduce the blind spots for the sensors in the vehicle front-rear direction, the aerodynamic performance of the vehicle decreases, and the rigidity of attachment parts of the sensors decreases. As a result, sensor accuracy may be decreased due to vibrations during traveling or wind influences.

One aspect of the present disclosure is to provide a vehicle sensor attachment structure in which a camera and a LIDAR configured to detect an external environment around a vehicle are attached to the vehicle. The vehicle sensor attachment structure includes a sensor unit in which the camera and the LIDAR are provided in an integrated manner, the sensor unit being attached to a front face or a rear face of a vehicle body of the vehicle.

In the vehicle sensor attachment structure according to one aspect of the present disclosure, the sensor unit in which the camera and the LIDAR are provided in an integrated manner is attached to the front face or the rear face of the vehicle body. Hereby, the number of man-hours for the attachment can be reduced in comparison with a case where the camera and the LIDAR are attached individually, and blind spots for the detection ranges ahead of and behind the vehicle can be reduced in comparison with a case where sensors are provided only on a roof of the vehicle.

In the vehicle sensor attachment structure according to one aspect of the present disclosure, the sensor unit may be attached to the vehicle body of the vehicle via a bracket provided as a separate body from the vehicle body.

The vehicle sensor attachment structure is a structure in which the sensor unit is attached to the vehicle body via the bracket provided as a separate body from the vehicle body. This allows easy attachment of the sensor unit to various vehicle bodies, thereby making it possible to raise the versatility of sensor-unit attachment.

In the vehicle sensor attachment structure according to one aspect of the present disclosure, the sensor unit attached to the front face of the vehicle body may be placed above a front bumper of the vehicle but below an exposed portion of a front windshield of the vehicle in a height direction of the vehicle body, or the sensor unit attached to the rear face of the vehicle body may be placed above a rear bumper of the vehicle but below an exposed portion of a rear windshield of the vehicle in the height direction of the vehicle body.

In the vehicle sensor attachment structure, the sensor unit attached to the front face of the vehicle body is placed above the front bumper of the vehicle but below the exposed portion of the front windshield of the vehicle. This makes it possible to restrain such a problem that a lower blind spot easily occurs due to the position of the sensor unit being too high or that the detection range of the sensor unit is easily blocked and the sensor unit easily receives dirt from road surfaces due to the position of the sensor unit being too low. This also applies to the sensor unit attached to the rear face of the vehicle body.

In the vehicle sensor attachment structure according to one aspect of the present disclosure, the sensor unit attached to the front face of the vehicle body may be placed closer to the vehicle body side than the front end of the front bumper, or the sensor unit attached to the rear face of the vehicle body may be placed closer to the vehicle body side than the rear end of the rear bumper.

In the vehicle sensor attachment structure, the sensor unit attached to the front face of the vehicle body is placed behind the front end of the front bumper in the vehicle front-rear direction. Accordingly, even in a case where the vehicle comes into contact with an object ahead of the vehicle, the above configuration can avoid the sensor unit from coming into contact with the object first, thereby making it possible to restrain a decrease in detection performance of the sensor unit due to the contact with the object. This also applies to the sensor unit attached to the rear face of the vehicle body.

With one aspect of the present disclosure, the camera and the LIDAR can be attached easily, and the number of man-hours for the attachment can be reduced in comparison with a case where the camera and the LIDAR are attached individually. Further, blind spots for the detection ranges ahead of and behind the vehicle can be reduced in comparison with a case where sensors are provided only on the roof of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view to describe a vehicle sensor attachment structure according to one embodiment;

FIG. 2 is a view to describe an exemplary attachment position of a sensor unit on a front face of a vehicle body;

FIG. 3 is a view to describe an exemplary detection range of the sensor unit;

FIG. 4 is a perspective view illustrating an example of the sensor unit;

FIG. 5 is a sectional view taken along a line V-V in FIG. 3; and

FIG. 6 is a sectional view taken along a line VI-VI in FIG. 3.

### DETAILED DESCRIPTION OF EMBODIMENTS

An embodiment of this disclosure will be described below with reference to the drawings. A vehicle sensor attachment structure in this disclosure is an attachment structure for a sensor unit provided on a front face or a rear face of a vehicle body of a vehicle. At least a camera and a light detection and ranging sensor (LIDAR) as sensors configured to detect an external environment around the vehicle are incorporated in the sensor unit in an integrated manner. The type of the vehicle and the shape of the vehicle body are not limited in particular. The external environment includes a state of other vehicles around the vehicle or a road surface, and so on.

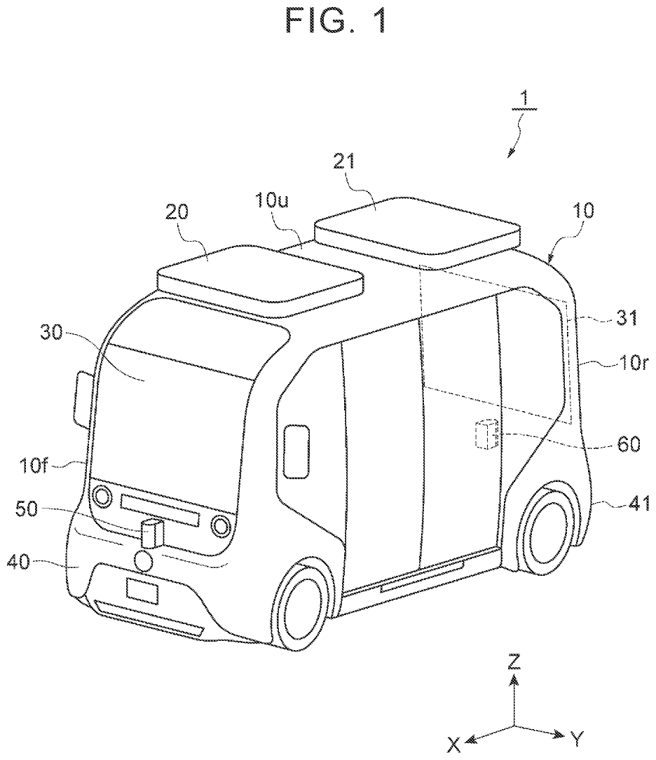

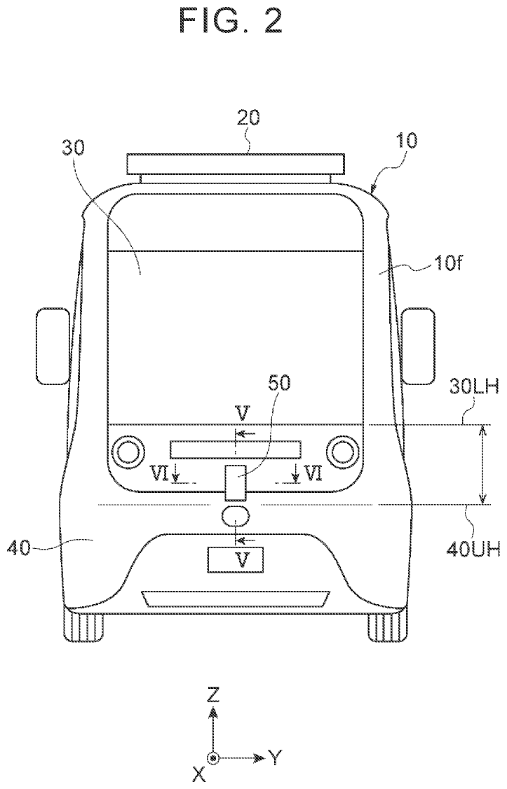

FIG. 1 is a perspective view to describe the vehicle sensor attachment structure according to one embodiment. FIG. 2 is a view to describe an exemplary attachment position of the sensor unit on the front face of the vehicle body. Each of the figures illustrates an XYZ rectangular coordinate system in which the vehicle-body front-rear direction is taken as an X-axis, the vehicle-body width direction is taken as a Y-axis, and the height direction of the vehicle body is taken as a Z-axis.

As illustrated in FIGS. 1, 2, the vehicle sensor attachment structure according to the present embodiment includes a sensor unit 50 provided on a vehicle-body front face 10f of a vehicle 1 (a vehicle body 10) and/or a sensor unit 60 provided on a vehicle-body rear face 10r. The vehicle 1 is a self-driving vehicle, for example.

A front roof sensor unit 20 and a rear roof sensor unit 21 are provided on a roof 10u of the vehicle body 10. At least a camera and a LIDAR are incorporated in each of the front roof sensor unit 20 and the rear roof sensor unit 21. Note that the vehicle 1 may not necessarily include the front roof sensor unit 20 and/or the rear roof sensor unit 21.

An exposed portion 30 of a front windshield and a front bumper 40 are provided on the vehicle-body front face 10f of the vehicle body 10. The exposed portion 30 of the front windshield is a part of the front windshield, the part being exposed in the front side of the vehicle body. The exposed portion 30 of the front windshield does not include a masking part. The front bumper 40 is a bumper provided in a front lower part of the vehicle body 10.

Similarly, an exposed portion 31 of a rear windshield and a rear bumper 41 are provided on the vehicle-body rear face 10r of the vehicle body 10. The exposed portion 31 of the rear windshield is a part of the rear windshield, the part being exposed in the rear side of the vehicle body. The exposed portion 31 of the rear windshield does not include a masking part. The rear bumper 41 is a bumper provided in a rear lower part of the vehicle body 10. The rear bumper 41 may be a part of the vehicle body 10, the part being molded to function as a bumper, or the rear bumper 41 may be provided as a separate member from the vehicle body 10. This also applies to the front bumper 40.

The sensor unit 50 on the vehicle-body front face 10f is placed above the front bumper 40 of the vehicle but below the exposed portion 30 of the front windshield of the vehicle in the height direction of the vehicle body 10. More specifically, as illustrated in FIG. 2, the sensor unit 50 can be placed to fall within a height range h between a height 30LH of the bottom end of the exposed portion 30 of the front windshield and a height 40UH of the upper end of the front bumper 40.

The sensor unit 50 is attached to the position of the center of the vehicle body 10 in the vehicle width direction (the extending direction of the Y-axis) as one example. The sensor unit 50 may be provided at a position displaced to the right or the left from the center of the vehicle body. Further, a plurality of sensor units 50 may be provided on the vehicle-body front face 10f In this case, the sensor units 50 may be provided bilaterally symmetrically on the vehicle-body front face 10f or may be provided on the right and left sides and on the center on the vehicle-body front face 10f.

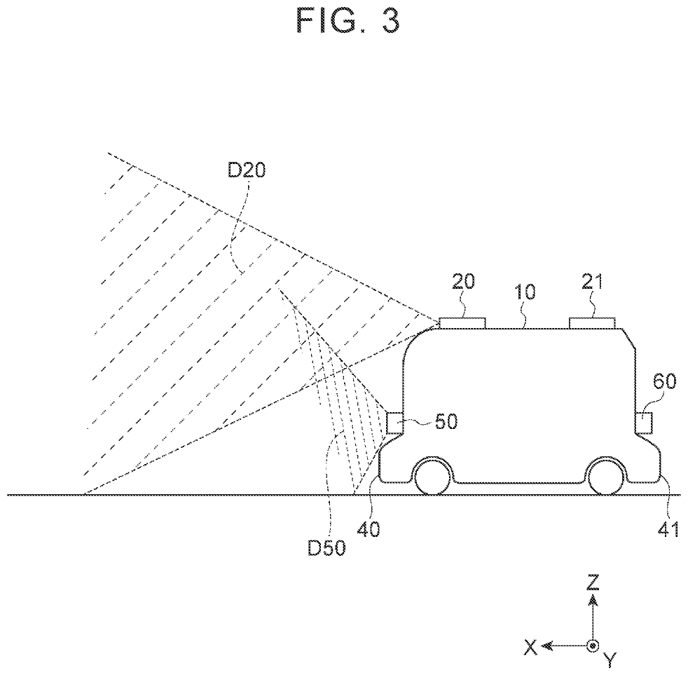

FIG. 3 is a view to describe an exemplary detection range of the sensor unit 50. FIG. 3 also illustrates the detection range of the front roof sensor unit 20 for reference. A detection range D20 of the front roof sensor unit 20 is blocked by the front end of the roof 10u, so that a blind spot occurs ahead of the vehicle body 10. In this respect, since the sensor unit 50 on the vehicle-body front face 10f has a detection range D60 covering the area ahead of the vehicle body 10, it is possible to detect an external environment around the front side of the vehicle appropriately.

Further, as illustrated in FIG. 3, the sensor unit 50 attached to the vehicle-body front face 10f is placed closer to the vehicle body 10 side than the front end of the front bumper 40 in the vehicle front-rear direction (the extending direction of the X-axis). That is, even in a case where the vehicle 1 comes into contact with an object ahead of the vehicle 1, the front bumper 40 comes into contact with the object earlier than the sensor unit 50.

The attachment position of the sensor unit 50 on the vehicle-body front face 10f has been described above. This also applies to the sensor unit 60 on the vehicle-body rear face 10r. The sensor unit 60 can be also attached to a position below the exposed portion 31 of the rear windshield of the vehicle 1 but above the rear bumper 41. The sensor unit 60 may be also provided at a position displaced to the right or the left from the center of the vehicle body, and a plurality of sensor units 60 may be provided. Further, the sensor unit 60 may be placed closer to the vehicle body 10 side than the rear end of the rear bumper 41 in the vehicle front-rear direction (the extending direction of the X-axis).

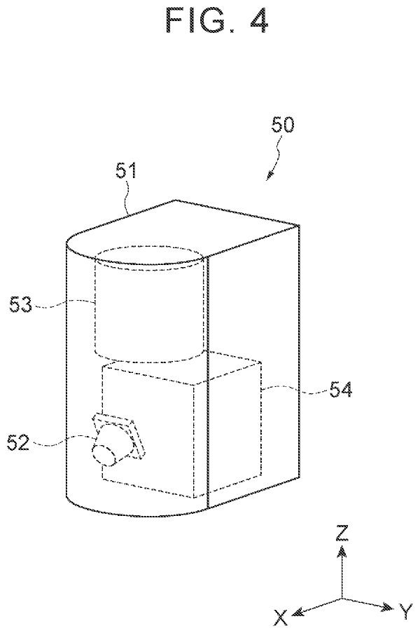

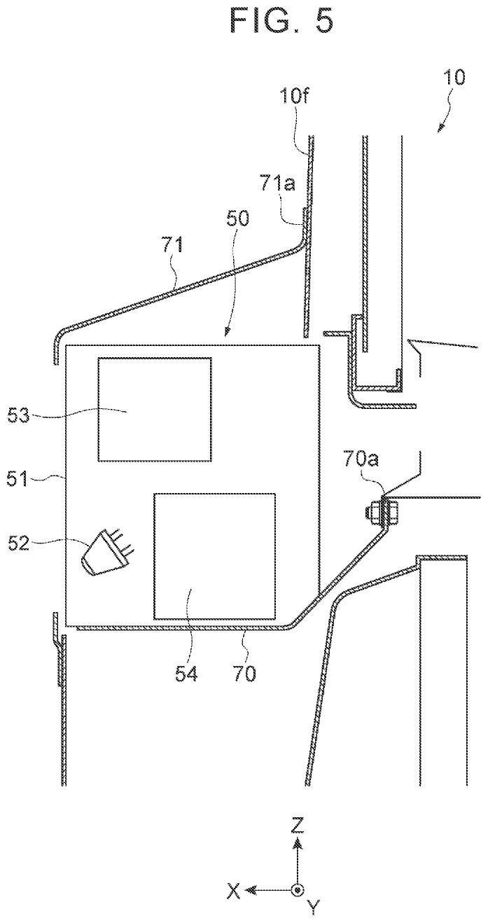

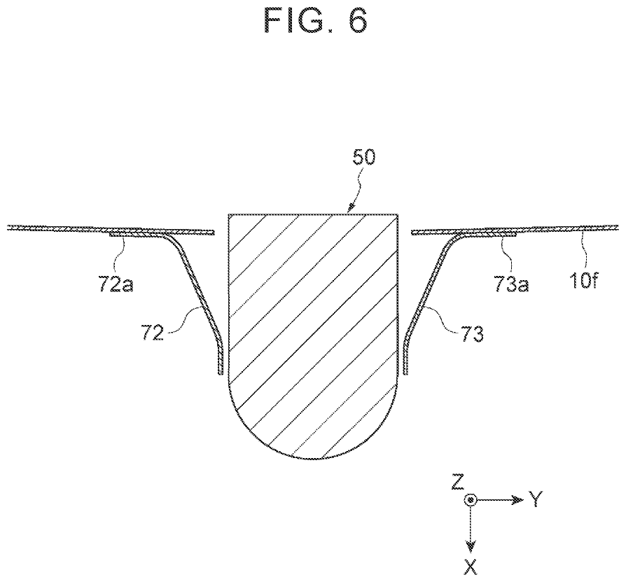

Next will be described the sensor unit 50 and its attachment structure with reference to FIGS. 4 to 6. FIG. 4 is a perspective view illustrating an example of the sensor unit 50. FIG. 5 is a sectional view taken along a line V-V in FIG. 3. FIG. 6 is a sectional view taken along a line VI-VI in FIG. 3. The sensor unit 60 on the vehicle-body rear face 10r can have a structure similar to that of the sensor unit 50, for example.

As illustrated in FIGS. 4 to 6, the sensor unit 50 includes a unit cover 51, a camera 52, a LIDAR 53, and a cleaning device 54.

The unit cover 51 is a cover member covering the camera 52 and the LIDAR 53 inside the sensor unit 50. Any material can be used for the unit cover 51 without any limitation, and the unit cover 51 may be made of resin or metal. The shape of the unit cover 51 is also not limited in particular, but the unit cover 51 can be formed in a pod shape, for example. The unit cover 51 can have a generally rectangular solid shape the front face (the outer face in the vehicle front-rear direction) of which is arcuately curved to project outwardly (see FIG. 6), for example. An opening for the camera 52 and the LIDAR 53, for example, is provided on the front face of the unit cover 51.

The camera 52 is an imaging device configured to capture an image of an external environment around the vehicle 1. The specification of the camera 52 is not limited in particular. The camera 52 may be a monocular camera or may be a stereoscopic camera. The camera 52 is connected to an electronic unit (e.g., an electronic control unit (ECU)) of the vehicle via a wiring line (not illustrated).

The LIDAR 53 is a detector configured to detect the external environment around the vehicle 1 by use of light. The LIDAR 53 is placed above the camera 52 inside the unit cover 51, for example. The LIDAR 53 transmits light to a region around the vehicle 1 and detects an object in the region by receiving light reflected from the object. The LIDAR 53 is also connected to the electronic unit of the vehicle via a wiring line (not illustrated).

The cleaning device 54 is a device configured to clean the camera 52 and the LIDAR 53. The cleaning device 54 is placed behind (on the vehicle body 10 side from) the camera 52, for example. The cleaning device 54 cleans a lens of the camera 52 and a detecting portion of the LIDAR 53 by air, water, cleaning solution, and the like, for example. The shape, the structure, and the function of the cleaning device 54 are not limited in particular. The cleaning device 54 is also connected to the electronic unit of the vehicle via a wiring line (not illustrated).

As illustrated in FIG. 5, the sensor unit 50 is attached to the vehicle body 10 via a bracket 70. The bracket 70 is a plate-shaped member, for example.

The bracket 70 is configured, for example, such that a first end (a rear end) 70a in the vehicle front-rear direction is bolted to the vehicle body 10 (a body panel), and a second end (a front end) is fixed to a bottom part of the sensor unit 50. A fixation method for fixing the bracket 70 to the sensor unit 50 is, for example, screwing. The shape and the fixation method of the bracket 70 are not limited in particular, provided that the sensor unit 50 can be attached to the vehicle body 10 via the bracket 70. The fixation method may be any of bolting, screwing, lug fitting, bonding, and welding. The bracket 70 may be constituted by a plurality of members.

As illustrated in FIGS. 5, 6, an upper cover member 71, a left cover member 72, and a right cover member 73 are provided around the sensor unit 50.

The upper cover member 71 is a plate-shaped member covering the upper face of the sensor unit 50 like a roof. The rear end (an end part on the vehicle body 10 side) of the upper cover member 71 is fixed to the vehicle body 10 (the body panel) by lug fitting. The front end (an end part on the front side in the vehicle front-rear direction) of the upper cover member 71 is formed to go around to the front-face side of the sensor unit 50. It is not necessary for the front end of the upper cover member 71 to be fixed to the sensor unit 50, and the upper cover member 71 may not make contact with the sensor unit 50.

The left cover member 72 is a plate-shaped member covering the left side face of the sensor unit 50. The rear end (an end part on the vehicle body 10 side) of the left cover member 72 is fixed to the vehicle body 10 (the body panel) by lug fitting. The front end of the left cover member 72 extends forward in the vehicle front-rear direction along the left side face of the sensor unit 50. The right cover member 73 is provided bilaterally symmetrically with the left cover member 72, and the rear end of the right cover member 73 is fixed to the vehicle body 10 by lug fitting.

Note that the front end of the upper cover member 71 may be fixed to the front face of the sensor unit 50. This also applies to the left cover member 72 and the right cover member 73. The shapes and the fixation methods of the upper cover member 71, the left cover member 72, and the right cover member 73 are just examples, and they are not limited to the above description.

In the vehicle sensor attachment structure according to the present embodiment described above, the sensor unit 50 in which the camera 52 and the LIDAR 53 are provided in an integrated manner is attached to the vehicle-body front face 10f. Accordingly, the number of man-hours for the attachment can be reduced in comparison with a case where the camera and the LIDAR are attached individually, and the blind spot for the detection range ahead of the vehicle can be reduced in comparison with a case where sensors are provided only on the roof. This also applies to the sensor unit 60 attached on the vehicle-body rear face 10r. As the vehicle height of the vehicle 1 is higher, the blind spot for the sensors on the roof increases. From this viewpoint, the attachment of the sensor unit 50, 60 is useful.

Further, in the vehicle sensor attachment structure, the sensor unit 50, 60 is attached to the vehicle body 10 via the bracket 70 as a separate body from the vehicle body 10. This allows easy attachment of the sensor unit 50, 60 to various vehicle bodies 10, thereby making it possible to raise the versatility of sensor-unit attachment.

In the vehicle sensor attachment structure, the sensor unit 50 attached to the vehicle-body front face 10f is placed above the front bumper 40 of the vehicle 1 but below the exposed portion 30 of the front windshield of the vehicle 1. This makes it possible to restrain such a problem that a lower blind spot easily occurs due to the position of the sensor unit 50 being too high or that the detection range of the sensor unit 50 is easily blocked and the sensor unit 50 easily receives dirt from road surfaces due to the position of the sensor unit 50 being too low. This also applies to the sensor unit 60 attached to the vehicle-body rear face 10r.

In the vehicle sensor attachment structure, the sensor unit 50 attached to the vehicle-body front face 10f is placed closer to the vehicle body 10 side than the front end of the front bumper 40. Accordingly, even in a case where the vehicle 1 comes into contact with an object ahead of the vehicle 1, the above configuration can avoid the sensor unit 50 from coming into contact with the object first, thereby making it possible to restrain a decrease in detection performance of the sensor unit 50 due to the contact with the object. This also applies to the sensor unit 60 attached to the vehicle-body rear face 10r.

The embodiment of the present disclosure has been described above, but the present disclosure is not limited to the above embodiment. The present disclosure can be performed in various forms including various alterations and modifications made based on the knowledge of a person skilled in the art, in addition to the above embodiment.

The vehicle sensor attachment structure according to this disclosure should include either one of the sensor unit 50 on the vehicle-body front face 10f and the sensor unit 60 on the vehicle-body rear face 10r. The vehicle 1 is not limited to a self-driving vehicle and may be a vehicle that can perform only a driving support control with manual driving, a pre-crash safety system, and so on.

The sensor unit 50 should include the camera 52 and the LIDAR 53, and the cleaning device 54 is not necessary. The sensor unit 50 may include a plurality of cameras 52 and a plurality of LIDARS 53. Further, the sensor unit 50 may include various sensors other than the camera 52 and the LIDAR 53. This also applies to the sensor unit 60.

Respective attachment positions of the sensor units 50, 60 are not limited to the positions described in the above embodiment. The sensor unit 50 may be attached to a height at which the sensor unit 50 partially or fully overlaps with the front bumper 40 or may be attached to a height at which the sensor unit 50 partially or fully overlaps with the exposed portion 30 of the front windshield. Respective positions of the sensor units 50, 60 in the vehicle front-rear direction are also not limited to the positions described in the above embodiment. The sensor unit 50 may partially project forward in the vehicle front-rear direction from the front end of the front bumper 40. These points also apply to the sensor unit 60.

The front face of the unit cover 51 of the sensor unit 50 should be configured not to largely prevent detection by the camera 52 or the LIDAR 53 and may be provided with a part through which light penetrates, instead of the opening. The bracket 70 is not necessary, and the sensor unit 50 may be directly attached to the vehicle body 10 side. The upper cover member 71, the left cover member 72, and the right cover member 73 may not be necessarily provided. These points also apply to the sensor unit 60.

What is claimed is:

1. A vehicle sensor attachment structure in which a camera and a LIDAR configured to detect an external environment around a vehicle are attached to the vehicle, the vehicle sensor attachment structure comprising a sensor unit in which the camera and the LIDAR are provided in an integrated manner, the sensor unit being attached to a front face or a rear face of a vehicle body of the vehicle.

2. The vehicle sensor attachment structure according to claim 1, wherein the sensor unit is attached to the vehicle body of the vehicle via a bracket provided as a separate body from the vehicle body.

3. The vehicle sensor attachment structure according to claim 1, wherein the sensor unit attached to the front face of the vehicle body is placed above a front bumper of the vehicle but below an exposed portion of a front windshield of the vehicle in a height direction of the vehicle body, or the sensor unit attached to the rear face of the vehicle body is placed above a rear bumper of the vehicle but below an exposed portion of a rear windshield of the vehicle in the height direction of the vehicle body.

4. The vehicle sensor attachment structure according to claim 3, wherein the sensor unit attached to the front face of the vehicle body is placed closer to the vehicle body side than a front end of the front bumper, or the sensor unit attached to the rear face of the vehicle body is placed closer to the vehicle body side than a rear end of the rear bumper.
